(19) United States
(12) Patent Application Publication
(10) Pub. No.: US 2002/0103826 A1
(43) Pub. Date: Aug. 1, 2002

(54) System and method for creating documents populated with variable data

(75) Inventors: John A. Kriho, LaGrange Park, IL (US); L. Katherine Reisz, Somerville, MA (US); M. Christian Hanson, Concord, MA (US)

Correspondence Address: Marc K. Weinstein, FOLEY & LARDNER, Washington Harbour, 3000 K Street, N.W., Suite 500, Washington, DC, 20007-5109, US

(73) Assignee: Banta Corporation

(21) Appl. No.: 09/770,462

(22) Filed: Jan. 29, 2001

(51) Int. Cl. G06F 15/00

(52) U.S. Cl. 707/505; 707/515

(57) ABSTRACT

A system and method for generating a printable document. The system and method includes receiving a document design and a plurality of data items over a network connection, the document design having one or more fields, each field linked to at least one of the plurality of data items, determining which data items are linked to each of the fields in the document design, and receiving a selection of which data item to include in each of the fields in the document design. The printable document is generated based on the document design and the received selection.

### FIELD OF THE INVENTION

The present invention relates generally to creating template documents for publishing or printing, and more particularly to a system and method for creating document templates that are populated with variable data and are stored in a local or wide area network.

### BACKGROUND OF THE INVENTION

To develop a publication or printed document, a user typically uses a page layout application. The page layout application enables the user to combine pictures, text, typography, writing, editing, and printing in one application and to have total command over page layout. Examples of publications or documents that may be produced include brochures, business cards, pamphlets, and catalogs.

To develop a publication, such as a catalog, the content of the catalog is selected, placed in the appropriate position and saved as a document for printing. Whenever the user seeks to update or change the content, the user must reopen the document, select the content to be changed, edit the selected content, and resave it. The editing of the selected content may require that new content be imported into the document to replace the selected content.

In the catalog, as well as other publications or documents, such as business cards and brochures, there are areas that are frequently changed or updated. For example, in the catalog, the items included in the catalog or the prices of those items may change every month. With respect to business cards, the design of the card may stay the same, but the names, addresses, telephone numbers and e-mail addresses may change repeatedly.

Although page layout applications are helpful in allowing the user to develop publications and documents having various types of content, there are some limitations, such as with respect to editing or updating the publication. To edit or update the publication, the user needs to have access to the publication, have access to the page layout application on which the publication was created, and have access to any content that may be used in place of existing content. However, the user may not be the author of the publication and thereby may not have access to the publication to make any changes. In addition, the user may not have access to the page layout application to effect the changes to the publication.

### SUMMARY OF THE INVENTION

Briefly, a method consistent with the present invention for designing a printable document comprises designing a document having one or more fields, linking one or more data items to each of the one or more fields in the document, and transmitting the document and the one or more data items over a network to a remote computer. The remote computer is then logged onto over the network, and the document is selected from a list of documents. One data item is identified from the one or more data items to place in each of the one or more fields in the document based on which of the one or more data items are linked to each of the one or more fields in the document. A file is received from the remote computer via the network having the document with the identified data item placed in each of the one or more fields.

In another aspect of the present invention, a method for generating a printable document comprises receiving a document design and a plurality of data items over a network connection, the document design having one or more fields, each of the one or more fields linked to at least one of the plurality of data items, determining which data items are linked to each of the one or more fields in the document design, and receiving a selection of which data item to include in each of the one or more fields in the document design. The printable document is generated based on the document design and the received selection.

### BRIEF DESCRIPTION OF THE DRAWINGS

FIG. 1 is a block diagram of a data merge system consistent with the present invention.

FIG. 2 is a flow diagram a document design process consistent with the present invention.

FIG. 3 is a flow diagram of a process for submitting a document to the data merge system consistent with the present invention.

FIG. 4 is a flow diagram of a process for storing a document submitted to the data merge system consistent with the present invention.

FIG. 5 is a diagram of a web form consistent with the present invention.

FIG. 6 is a flow diagram of a process for populating information in a document stored in the data merge system consistent with the present invention.

FIG. 7 is a flow diagram of a process for transmitting a document populated with information from the data merge system consistent with the present invention.

### DETAILED DESCRIPTION OF THE PREFERRED EMBODIMENT

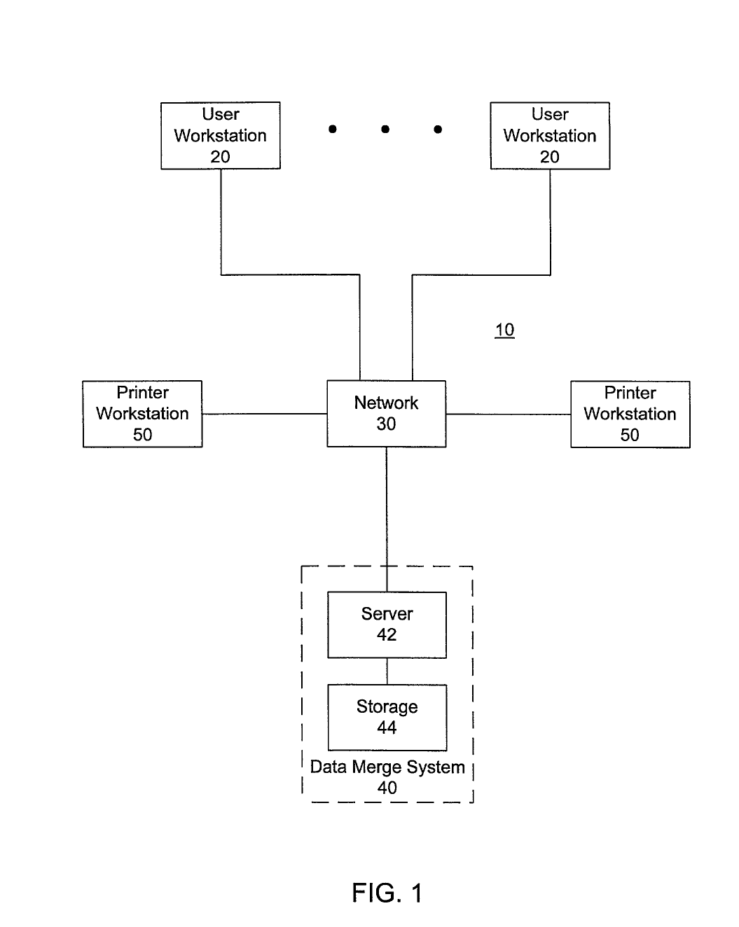

FIG. 1 is a block diagram of a document production system 10 consistent with the present invention. As shown in FIG. 1, the document production system 10 includes one or more user workstations 20, a network 30, a data merge system 40, and one or more printer workstations 50. The user workstation 20 and the printer workstations 50 may connect to the data merge system 40 via the network 30.

The user workstation 20 may include a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage medium.

A communication interface provides a two-way data communication coupling via a network link to the network 30. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 30. The network 30 may be implemented, for example, as a LAN or as a public network, such as the Internet.

The user workstation 20 can send messages and receive data, including program code, through the network 30. If the network 30 is implemented as the Internet, the data merge system 40 can transmit a requested code for an application program through the Internet, an ISP, the local network and the communication interface. The received code can be executed by the CPU in the workstation of the user workstation 20 as it is received, stored in the storage device, or stored in some other non-volatile storage for later execution. In this manner, the user workstation 20 may obtain application code in the form of a carrier wave.

Each printer workstation 50 may be implemented in the same manner as the user workstation 20. In particular, each printer workstation 50 may include a CPU, a main memory, a ROM, a storage device and a communication interface all coupled together via a bus. Each printer workstation 50 may also include a communication interface, which provides a two-way data communication coupling via a network link to the network 30. Like the user workstation 20, the printer workstation 50 can send messages and receive data, including program code, through the network 30.

The data merge system 40 includes a server 42 and a storage 44. The server 42 may have the same elements as the user workstation 20 and the printer workstation 50, including a CPU, a main memory, a ROM, and a communication interface all coupled together via a bus. The storage 44 may be implemented as a non-volatile storage that may be incorporated into the server 42 or may be outside of the server 42. The storage 44 may be implemented as a single storage device or may be a plurality of storage devices located in a single location or distributed across multiple locations. The storage 44 includes a database, which stores information regarding the different documents that may be generated by the data merge system 40.

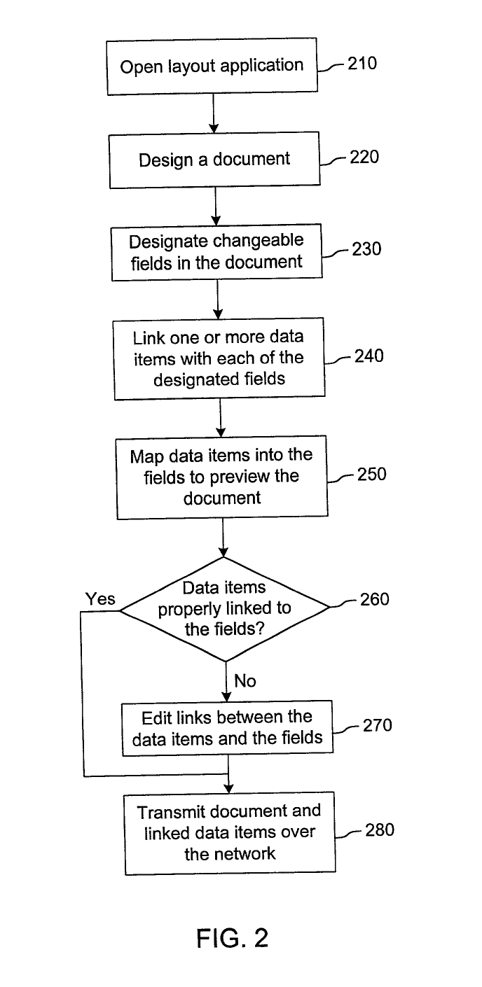

FIG. 2 is a flow diagram of a document design process consistent with the present invention. As shown in FIG. 2, a user first opens a layout application (step 210). The layout application may be resident on the user workstation 20 or resident on a server that is accessed by the user workstation via the network 30, which may be implemented as a LAN or the Internet. The layout application consistent with the present invention may be a page layout application, such as QuarkXPress, or an extension or plug-in to an existing page layout application. The layout application preferably enables the user to combine pictures, text, typography, writing, editing, and printing in one application and to have total command over page layout.

The user then designs a document using the layout application (step 220). The layout application may be used to generate a document design, such as for a business card, a brochure, or other publication or printable document. As discussed above, the document design may include pictures, images, text, figures or other type of content.

Within the document design, the user also designates changeable fields (step 230). The changeable fields correspond to areas in the document design which may be linked to one or more data items. Any of the data items linked to the changeable field may be included in the document design to produce a printable document. The data items may comprise any type of content, including images, text or pictures. The changeable field may correspond to a particular area of the document design that is designated by the user. The user may designate the particular area with an input, such as from a mouse, that defines the area in a particular shape, such as a square or rectangle, in which the data item may appear. For example, the changeable field may be defined as a rectangle of a particular size in which an image, such as a picture, is to appear.

The user then links one or more data items to each of the fields in the document design (step 240). To link the data item to the field, the user selects the data item to be linked and provides an indication as to which of the fields the data item is to be linked. A list of the fields and a list of the data items may be displayed to the user to facilitate the linking. With the fields and data items displayed, the user may highlight one of the fields, and then select the data items, such as by a mouse click, which are linked to the highlighted field. The user may link a data item to more than one field.

After linking the data items to the fields in the document design, the data items are mapped into the fields to provide a preview of the document design (step 250). If more than one data item is linked to a field, then the user may designate which data item should be mapped to the field for the preview. Alternatively, a default selection may be used, which designates, for example, the first data item or a random data item linked to the field to be shown in the preview. In addition, the preview may be shown iteratively so that each data item may be shown. For example, if each field had three data items linked to it, three different previews may be shown to allow each data item to be shown at least once.

From the preview of the document design, the user determines whether or not the data items are properly linked to the fields (step 260). By showing the preview of the document design iteratively so that each data item is shown in the field to which it is linked, the user can verify that each data item has been linked properly. If a data item has not been linked properly or if the user wants to change a link, the user can edit the links between the data items and the fields (step 270). The user edits the links in the same manner in which the user made the links in the first place. Once the user is satisfied with the links between the data items and the fields, the user transmits the document design and the linked data items over the network 30 to the data merge system 40 (step 280).

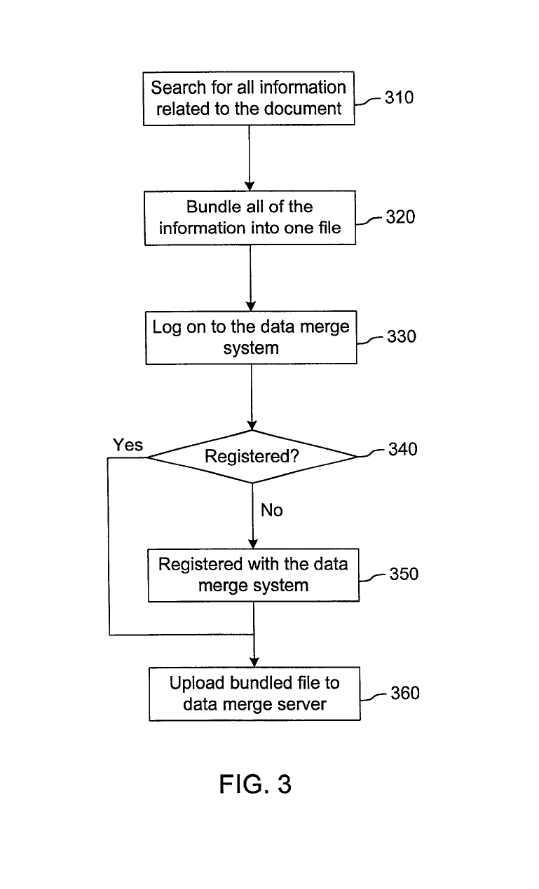

FIG. 3 is a flow diagram of a process for submitting a document to the data merge system 40 consistent with the present invention. When the user is ready to transmit the document design and linked data items over the network 30, a search is first made for all of the information related to the document design (step 310). In addition to the document design itself, the related information includes the linked data items, identification of the various fields in the document design, the author of the document design, font information, and any other information that may be useful in identifying or reproducing the document design. This information may be located in a storage in the user workstation 20 or in a centralized storage accessible to the user workstation, such as a server in a LAN.

The located information is then bundled all together into a single file for transmission over the network 30 (step 320). The format of this bundled file may depend on the page layout application in which the document design was formed. Alternatively, the file may be created in a format consistent with the data merge system 40 or in a neutral format, such as XML.

Before the file is transferred to the data merge system 40, the user first logs onto the data merge system 40 (step 330). If the network 30 is implemented as the Internet, the user may log onto the data merge system 40 by accessing the Internet from the user workstation 20 and going to the web site of the data merge system 40. Alternatively, if the network 30 is implemented as a LAN, then the data merge system 40 may be accessible to any user workstation 20 in the LAN that has access to the server 42 of the data merge system 40.

After logging onto the data merge system 40, it is determined whether or not the user is registered with the data merge system 40 (step 340). Although registration is not required, it is preferable to include a registration of all users of the data merge system 40 to ensure that only proper users are given access to the data merge system 40. By registering with the data merge system 40, the user may be given a username and password, which are entered when logging onto the data merge system 40 to verify that the user has registered with the data merge system 40.

If the user has not yet registered with the data merge system 40, the user is prompted to do so (step 350). Registration with the data merge system 40 may require the user to provide identification information, location information, and possibly payment information. The user's registration information may be stored in the storage 44 so that it may be accessed each time the user subsequently logs onto the data merge system 40.

Once the user provides the username and password to verify their registration, the file holding all of the information related to the document design is uploaded to the server 42 of the data merge system 40 (step 360). The file may be transferred in a format corresponding to the transmission protocol of the network, such as TCP/IP. The uploaded file received by the server 42 may then be stored in the storage 44.

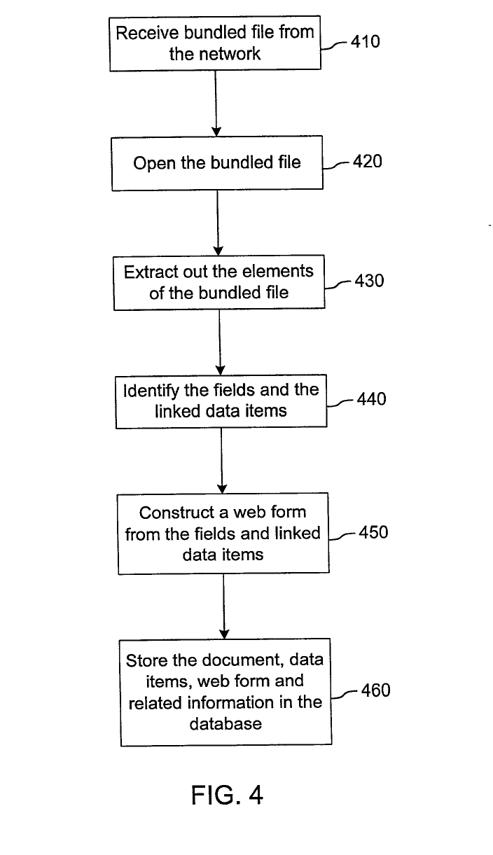

FIG. 4 is a flow diagram of a process for storing a document submitted to the data merge system 40 consistent with the present invention. As shown in FIG. 4, the data merge system 40 receives the bundled file that has been uploaded by the user over the network 30 to the server 42 (step 410). The bundled file, as described above, includes the document design, the linked data items, identification of the various fields in the document design, the author of the document design, font information, and any other information that may be useful in identifying or reproducing the document design.

The received file is then opened by the data merge system 40 (step 420). With the file opened, each of the elements of the file is extracted (step 430). The extraction of each of the elements of the file involves separating all of the elements that have been bundled into the file received by the data merge system, i.e., the document design, the linked data items, the identification of the various fields in the document design, the author of the document design, the font information, and any other information that may be useful in identifying or reproducing the document design. The extracted elements are stored in the storage 44. A database may be held in the storage 44, which keeps track of each of the extracted elements and links them as being from the received bundled file.

From the extracted elements of the bundled file, the data merge system 40 identifies the fields in the document design and the data items linked to each of the fields (step 440). Based on the identified fields and the linked data items, the data merge system 40 constructs a web form (step 450). The web form is a form through which the user can designate which of the data items to include in the document design. The web form may appear as a window in a graphical user interface (GUI) provided by the server 42 of the data merge system.

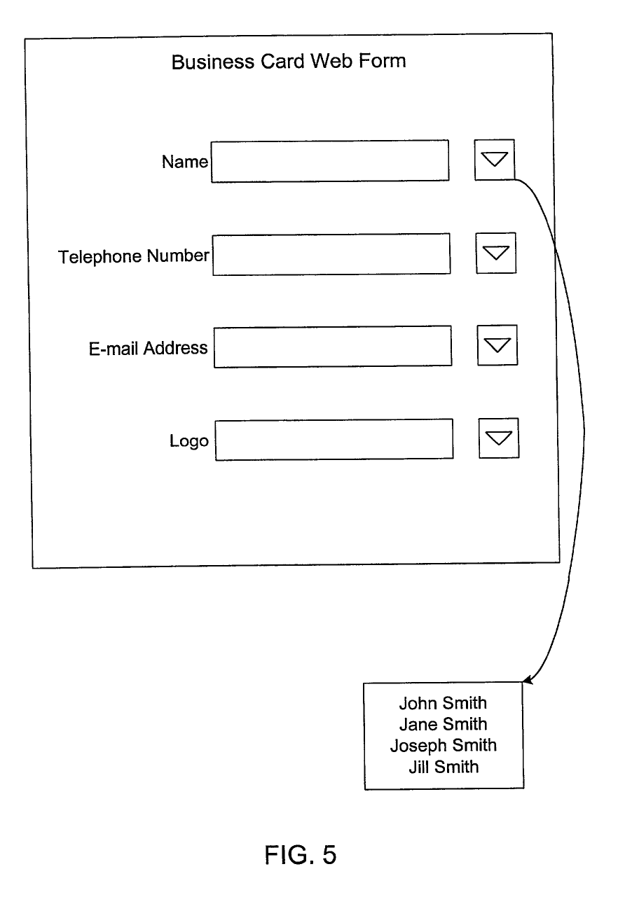

FIG. 5 shows an example of a web form consistent with the present invention. As shown in FIG. 5, the web form is for a business card and is shown as a window in a GUI provided by the server 42 and displayed to the user at the user workstation 20. The web form includes four separate fields. Each field includes a name or description as to the content that is to be included in that field. In FIG. 5, the fields are for a name, a telephone number, an e-mail address and a logo. Next to each field is a button that may be selected, such as with a key stroke or a mouse click. In response to the selection of the button, a list of the data items that are linked to the particular field are displayed to the user. For example, if the user selected the button next to the name field, a list of names would appear, preferably in a separate window of the GUI. As shown in FIG. 5, the selection of the button next to the name field generates the separate window with four names. From the list of names, the user selects which name the user wants to appear in the document design. The user may make the selection, for example, with a key stroke or a mouse click. Instead of using the data items linked to the field based on selecting the button, the user may simply enter content through a text box associated with the field.

The web form of FIG. 5 is merely an example. The web form may be constructed in any other manner which facilitates the user in selecting data items that are linked to each of the fields of the document design. For example, the fields may simply be displayed in a menu, whereby the selection of a field from the menu causes another menu to display the data items linked with the selected field. In addition to selecting the data item from the menu, the user may also be able to modify attributes of the data item, such as its color, size or alignment.

The web form is then stored in the storage 42 along with extracted elements of the bundled file (step 460). The database maintained in the storage 42 may be updated to reflect that the web form stored in the storage 42 is related to the extracted elements of the bundled file. The indication of the relationship between the web form and the extracted elements, which includes the fields and linked data items, helps facilitate the use of the web form to select the appropriate data items for each field in the document design.

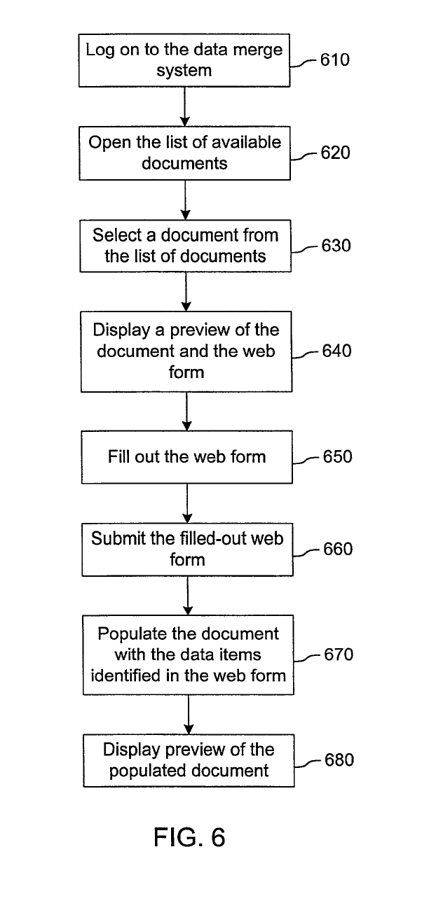

With the bundled file uploaded to the data merge system 40, the user is free to use the document design associated with the bundled file to create complete printable documents. FIG. 6 is a flow diagram of a process for populating information in the document design stored in the data merge system 40 consistent with the present invention. As shown in FIG. 6, the first step is to log onto the data merge system 40 (step 610). As discussed above, if the network 30 is implemented as the Internet, the user may log onto the data merge system 40 by accessing the Internet from the user workstation 20 and going to the web site of the data merge system 40. Alternatively, if the network 30 is implemented as a LAN, then the data merge system 40 may be accessible to any user workstation 20 in the LAN that has access to the server 42 of the data merge system 40. To ensure that only authorized users are accessing the data merge system 40, the user may be required to enter a registered username and password to gain access.

After logging onto the data merge system 40, the user may open a list of available documents (step 620). The list of documents may include every document design that has been uploaded to the data merge system 40. Alternatively, the list of documents may be limited to the document designs that have been uploaded to the data merge system 40 by the user. To identify the document designs uploaded by the user, the data merge system 40 may use identification information stored in the storage 44 when the user registered that corresponds to the username provided by the user, and compare the identification information to the database maintained in the storage 44, which keeps track of the document designs and the associated elements that have been uploaded to the data merge system 40 as a bundled file. The list of documents available to the user may be shown as a window in the GUI provided by the server 42.

The user may then select a document from the list of documents (step 630). If the documents are listed in a window of the GUI, the user may effect the selection of the document with a key stroke or a mouse click. In response to the selection of the document, a preview of the document along with its associated web form is displayed (step 640). The preview of the document shows the document as designed by the user, but without any content in any of the fields of the document design. The preview of the document allows the user to verify that the selected document corresponds to the document design with which the user wants to work. The web form, as described above, shows each of the fields associated with the document design and allows the user to either enter content for each field or to select a data item that has been linked to the field.

With the web form associated with the document displayed, the user fills out the web form (step 650). As described above, the web form may appear as a separate window in the GUI of the server 42, or as a menu. In the window, the web form includes a name or description of each field associated with the selected document. In addition, each field preferably includes an associate box through which the user may enter content to be shown for the field, and a button. The button may be depressed, such as in response to a key stroke or mouse click, and display a list of data items that are linked to the field associated with the button. The user may then select a data item for the list with a key stroke or mouse click, so that the selected data item is to be displayed in the field to which it is linked. When the user has completed the web form, the user submits the completed web form to the data merge system 40 (step 660).

Using the information from the submitted web form, the data merge system 40 populates the selected document with the data items identified in the web form (step 670). For each field in the document, the data merge system 40 identifies the data item selected by the user based on the submitted web form, identifies the location of the field in the document design, and places the identified data item at the identified location. The data merge system 40 may include a utility for fitting the selected data item in the associated field. For example, if the field is a rectangular box of a certain size, the data item selected to appear in the field may need to be adjusted to fit in the rectangular box. If the selected data item is text, then the data merge system 40 may change the font size of the text to make it fit. If the selected data item is an image, then the data merge system 40 may change the resolution or pixel density or the display scale to ensure the image fits in the rectangular box. Other changes may be made to the data item to make the data item fit appropriately.

A preview of the populated document is then displayed to the user (step 680). The preview of the populated document enables the user to review the document and ensure that the document appears in the way the user desired. In addition to displaying the preview to the user, the preview of the document may be sent to the user in a particular format, such as .pdf. The preview may be sent to the user by e-mail, or by other transport mechanisms, such as FTP.

If the user wishes to make changes, the user can change the data items that have been selected to appear in the fields of the document. For example, the user may click on a particular field, which would cause the data items linked to the field to be displayed and allow the user to change the data item selected. In addition, the user may change the content of the data item, as well as the content of the document design, using the same page layout application in which the document was designed in the first place, such as QuarkXPress. Alternatively, an editor may be used to change the content in accordance with the type of content. For example, text may be changed using a text editor, such as Microsoft Word, and an image may be changed using an image editor, such as Photoshop, a product of Adobe.

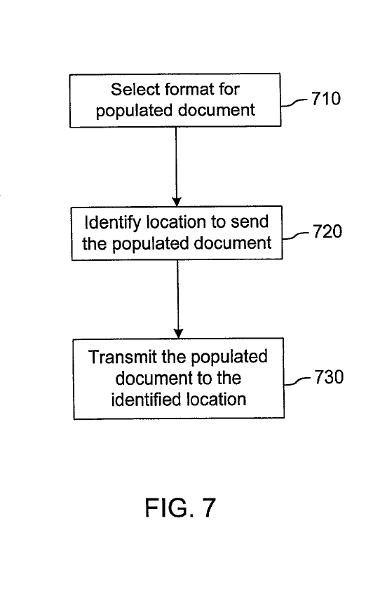

Having created a populated and complete document, the user may now receive the completed document or forward the completed document to a printer. FIG. 7 is a flow diagram of a process for transmitting a document populated with information from the data merge system consistent with the present invention. As shown in FIG. 7, the user first designates the format for the completed document (step 710). The format for the completed document may be, for example, .pdf or other common or neutral formatting that may be interpreted by most computers. Alternatively, the user may designate a format corresponding to a know page layout application or a known printing application.

After selecting the format of the completed document, the user identifies the location to send the completed document (step 720). The user may send the completed document to the user, such as by e-mail or by FTP. Alternatively, the user may elect to have the document sent to the printer workstation 50. The printer workstation 50 may be a professional printing company used by the user to produce publications from the document. If the user elects to have the document sent to the printer workstation 50, the user may also provide a message or information relating to the printing request of the user, such as how many, on what size paper, on what type of paper, etc. Based on the identified location and any printing information, the completed document is transmitted (step 730). The transmission is preferably by e-mail, although other conventional transmission types may be used.

In addition to creating printable documents from a document design having fields linked to selectable data items, the data merge system 40 may also be used to do mail merges. To do the mail merges, the user prepares a document design with one or more fields in it. For example, if the document design is a letter for mass mailing, the fields may be for a name and an address. The document design and fields is uploaded to the data merge system 40 and stored in the database maintained in the storage, as described above.

To effect a mail merge, the user creates a mailing list. The mailing list includes the information to link to the fields of the document design. For the example of the client letter, the mailing list would include all of the names and addresses for the mass mailing. After creating the mailing list, the user uploads it to the data merge system 40. Based on information in the mailing list, the data merge system 40 recognizes the relationship of the mailing list with the previously uploaded document design. The data merge system 40 then creates a different document for each part of the mailing list using the related document design. In the example of the mass mailing letter, the data merge system 40 would automatically place each name and address in the appropriate fields of the letter and produce a different letter for each set of names and addresses in the mailing list. Each document produced may then be sent back to the user as a multi-page document in a desired format, such as .pdf or other supported print output format. For the mass mailing letter, the number of pages in the multi-page document would correspond to the number of letters.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and as a practical application to enable one skilled in the art to utilize the invention in various embodiments and with various modifications that are suited to the particular use contemplated. It is intended that the scope of the invention be defined by the claims appended hereto and their equivalents.

What is claimed is:

1. A method for designing a printable document, comprising:
designing a document having one or more fields;
linking one or more data items to each of the one or more fields in the document;
transmitting the document and the one or more data items over a network to a remote computer;
logging onto the remote computer over the network;
selecting the document from a list of documents;
identifying one data item from the one or more data items to place in each of the one or more fields in the document based on which of the one or more data items are linked to each of the one or more fields in the document; and
receiving a file from the remote computer via the network having the document with the identified data item placed in each of the one or more fields.

2. A method according to claim 1, further comprising:
populating the one or more fields of the document with the identified data items.

3. A method according to claim 2, further comprising:
previewing the document with the identified data items populating the one or more fields before receiving the file.

4. A method according to claim 3, further comprising:
modifying the design of the document or the identified data items after previewing the document.

5. A method according to claim 2, further comprising:
adjusting the size of each of the identified data items based on the size of the one or more fields to which the identified data items are linked.

6. A method according to claim 1, further comprising:
locating the designed document and the linked data items; and
bundling the designed document and the linked data items into a single file,
wherein the step of transmitting includes transmitting the single file.

7. A method according to claim 1, wherein the step of linking further includes preparing a mailing list, the mailing list including address information linked to at least one of the one or more fields of the document.

8. A method according to claim 7, wherein the mailing list includes a predetermined number of pairs of name and address information, the method further comprising:
populating the at least one of the one or more fields of the document with each of the predetermined number of pairs of name and address information.

9. A method according to claim 8, wherein the received file includes a number of versions of the document corresponding to the predetermined number of pairs, each version of the document including a respective one of the predetermined number of pairs.

10. A method for generating a printable document, comprising:
receiving a document design and a plurality of data items over a network connection, the document design having one or more fields, each of the one or more fields linked to at least one of the plurality of data items;
determining which data items are linked to each of the one or more fields in the document design;
receiving a selection of which data item to include in each of the one or more fields in the document design; and
generating the printable document based on the document design and the received selection.

11. A method according to claim 10, further comprising:
creating a form for the document design based on the one or more fields, each form having an entry for each of the one or more fields.

12. A method according to claim 11, further comprising:
displaying a list of the at least one of the plurality of data items for each entry in the form.

13. A method according to claim 12, wherein the receiving of the selection includes receiving an indication of which data item from the list to provide in each entry in the form, and
wherein the printable document is generated based on the indication.

14. A computer readable medium operable on a computer system for designing a printable document, the computer readable medium configured to:
design a document having one or more fields;
link one or more data items to each of the one or more fields in the document;
transmit the document and the one or more data items over a network to a remote computer;
log onto the remote computer over the network;
select the document from a list of documents;
identify one data item from the one or more data items to place in each of the one or more fields in the document based on which of the one or more data items are linked to each of the one or more fields in the document; and
receive a file from the remote computer via the network having the document with the identified data item placed in each of the one or more fields.

15. A computer readable medium according to claim 14, further configured to:
populate the one or more fields of the document with the identified data items.

16. A computer readable medium according to claim 15, further configured to:
preview the document with the identified data items populating the one or more fields before receiving the file.

17. A computer readable medium according to claim 16, further configured to:
modify the design of the document or the identified data items after previewing the document.

18. A computer readable medium according to claim 15, further configured to:
adjust the size of each of the identified data items based on the size of the one or more fields to which the identified data items are linked.

19. A computer readable medium according to claim 14, further configured to:
locate the designed document and the linked data items;
bundle the designed document and the linked data items into a single file; and
transmit the single file.

20. A computer readable medium according to claim 14, further configured to:
prepare a mailing list, the mailing list including address information linked to at least one of the one or more fields of the document.

21. A computer readable medium according to claim 20, wherein the mailing list includes a predetermined number of pairs of name and address information, the computer readable medium further configured to:
populate the at least one of the one or more fields of the document with each of the predetermined number of pairs of name and address information.

22. A computer readable medium according to claim 21, wherein the received file includes a number of versions of the document corresponding to the predetermined number of pairs, each version of the document including a respective one of the predetermined number of pairs.

23. A computer readable medium operable on a computer system for generating a printable document, the computer readable medium configured to:
receive a document design and a plurality of data items over a network connection, the document design having one or more fields, each of the one or more fields linked to at least one of the plurality of data items;
determine which data items are linked to each of the fields one or more in the document design;
receive a selection of which data item to include in each of the one or more fields in the document design; and
generate the printable document based on the document design and the received selection.

24. A computer readable medium according to claim 23, further configured to:
create a form for the document design based on the one or more fields, each form having an entry for each of the one or more fields.

25. A computer readable medium according to claim 24, further configured to:
display a list of the at least one of the plurality of data items for each entry in the form.

26. A computer readable medium according to claim 25, further configured to:
receive an indication of which data item from the list to provide in each entry in the form; and
generate the printable document based on the indication.

27. A computer system for designing a printable document, comprising:
a processor; and
a memory which stores a plurality of instructions executed by the processor, the plurality of instructions configured to:
design a document having one or more fields;
link one or more data items to each of the one or more fields in the document;
transmit the document and the one or more data items over a network to a remote computer;
log onto the remote computer over the network;
select the document from a list of documents;
identify one data item from the one or more data items to place in each of the one or more fields in the document based on which of the one or more data items are linked to each of the one or more fields in the document; and
receive a file from the remote computer via the network having the document with the identified data item placed in each of the one or more fields.

28. A computer system according to claim 27, the memory further comprising an instruction configured to:
populate the one or more fields of the document with the identified data items.

29. A computer system according to claim 28, the memory further comprising an instruction configured to:
preview the document with the identified data items populating the one or more fields before receiving the file.

30. A computer system according to claim 29, the memory further comprising an instruction configured to:
modify the design of the document or the identified data items after previewing the document.

31. A computer system according to claim 28, the memory further comprising an instruction configured to:
adjust the size of each of the identified data items based on the size of the one or more fields to which the identified data items are linked.

32. A computer system according to claim 27, the memory further comprising instructions configured to:
locate the designed document and the linked data items;
bundle the designed document and the linked data items into a single file; and
transmit the single file.

33. A computer system according to claim 27, the memory further comprising an instruction configured to:
prepare a mailing list, the mailing list including address information linked to at least one of the one or more fields of the document.

34. A computer system according to claim 33, wherein the mailing list includes a predetermined number of pairs of name and address information, the memory further comprising an instruction configured to:
populate the at least one of the one or more fields of the document with each of the predetermined number of pairs of name and address information.

35. A computer system according to claim 34, wherein the received file includes a number of versions of the document corresponding to the predetermined number of pairs, each version of the document including a respective one of the predetermined number of pairs.

36. A computer system for generating a printable document, comprising:
a processor; and
a memory which stores a plurality of instructions executed by the processor, the plurality of instructions configured to:
receive a document design and a plurality of data items over a network connection, the document design having one or more fields, each of the one or more fields linked to at least one of the plurality of data items;
determine which data items are linked to each of the one or more fields in the document design;
receive a selection of which data item to include in each of the one or more fields in the document design; and
generate the printable document based on the document design and the received selection.

37. A computer system according to claim 36, the memory further comprising an instruction configured to:
create a form for the document design based on the one or more fields, each form having an entry for each of the one or more fields.

38. A computer system according to claim 37, the memory further comprising an instruction configured to:
display a list of the at least one of the plurality of data items for each entry in the form.

39. A computer system according to claim 38, the memory further comprising instructions configured to:
receive an indication of which data item from the list to provide in each entry in the form; and
generate the printable document based on the indication.
